(19) United States
(12) Patent Application Publication
(10) Pub. No.: US 2005/0167557 A1
(43) Pub. Date: Aug. 4, 2005

(54) Retaining device

(75) Inventor: Mathilde Winckels, Clichy (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: L'OREAL, Paris (FR)

(21) Appl. No.: 10/979,200

(22) Filed: Nov. 3, 2004

Related U.S. Application Data
(60) Provisional application No. 60/519,651, filed on Nov. 14, 2003.

(30) Foreign Application Priority Data
Nov. 4, 2003 (FR) 03 50782

(51) Int. Cl. F16L 21/00

(52) U.S. Cl. 248/311.2

(57) ABSTRACT

A retaining device for an object including a plate incorporating an aperture allowing the insertion and withdrawal of the object. A lower face of the plate is attached to a support by a connecting arrangement, and a separation movement between the plate and the support causes deformation of the connecting arrangement so as to form a sleeve around the object. Walls of the connecting arrangement are preferably defined radially relative to the object and facilitate its protection. The device can be advantageously mounted inside a case capable of accommodating the object.

### CROSS REFERENCE TO RELATED APPLICATIONS

This document claims priority to French Application Number 03 50782, filed Nov. 4, 2003 and U.S. Provisional Application No. 60/519,651, filed Nov. 14, 2003, the entire contents of which are hereby incorporated by reference.

### BACKGROUND OF THE INVENTION

1.Field of the Invention

The invention relates to a retaining device that can, for example, be used to secure an object in a case. By way of example, the device can be used in the field of dispensing and/or packaging devices disposed in cardboard cases of generally parallelepiped shape. The objects packaged therein can have a different envelope outline or profile, e.g., smaller than that of the parallelepiped formed by the cardboard case.

2. Discussion of Background

FR-A-2,571,028 describes a sleeve fashioned from a cellular structure capable of being mounted about an object to be protected or concealed. This sleeve has a structure similar to that provided for a pot cover. The sleeve is described as being deformable, and is designed to adapt to the shape of the object and make elastic contact therewith. This type of sleeve can be mounted around objects having different outside diameters. However, in the case where the objects can have different heights, the sleeve might not be adaptable to cover the object or objects over their full height. In effect, the sleeve thus formed is only radially extensible and is not vertically adaptable.

In addition, with the above arrangement, because the cellular structure is designed to present properties of radial extension such that each cell has at least two walls oriented parallel to an axis of insertion of the object into the sleeve, such a structure is not capable of compressing on itself so as to present a minimum vertical size when not in use. When not in use, the sleeve retracts radially on itself, but retains generally the same height. At best, in the absence of an object to be protected, such a sleeve will present the outline of a cylinder having a small outside diameter. In effect, the minimum height of each level of such a cellular structure corresponds to the height along the axis of these walls parallel to this axis. Because the cellular structure has several levels superimposed on each other relative to the axis, the minimum height of such a structure corresponds to the sum of the heights of the walls parallel to the axis. Moreover, this minimum height cannot be achieved at rest, and is obtained only when maximum radial constraint is applied thereto.

Another problem with these sleeves is that they require complex manipulation and cannot be readily handled by packaging machines. Packaging therefore has to be accomplished manually. While a first hand separates the inner edges of the sleeve compressed on itself, the other hand has to skillfully grasp the object to be inserted and, without letting go of either, insert the object into the sleeve. Such handling requires a great deal of care if one is to avoid damaging the external finish of the sleeve and/or avoid impairing the protective function normally provided by this type of sleeve.

Another known device, described in document FR-2,635,754, includes a packaging bag having a variable capacity, with side walls formed by a bellows to allow variation of the height of the cylinder-shaped bag. This bag poses a problem in that it fails to protect the objects it contains against external impacts, particularly when the impacts are exerted radially in relation to the outer surface of the side walls. This bag poses another problem in that the outer envelope surface which it defines is necessarily cylindrical and circular in cross-section. It is therefore not possible to readily secure such a bag in a parallelepiped package of larger size. Similarly, an object placed inside such a bag will not be retained and is likely to remain loose if it has a shape other than cylindrical and circular in cross-section.

### SUMMARY OF THE INVENTION

An object of the invention is to resolve, in whole or in part, problems described above.

According to one feature, an arrangement is provided which is capable of surrounding and protecting an item to be retained, in a manner such that the arrangement is also capable of assuming minimum dimensions when not in use, and which is simple to mount around the item. According to a preferred example of the invention, the arrangement is variable in shape and can present an outer envelope surface having a non-circular cross-section and/or a shape different from that of the object to be retained. Similarly, the internal space formed to accommodate the object is not necessarily cylindrical or circular in cross-section and can adapt to objects having a complex shape.

According to a preferred form, a retaining device for an object is provided which includes a plate having an aperture allowing insertion and withdrawal of the object. A lower face of the plate is attached to a support by a deformable connecting arrangement. In addition, a separating movement between the plate and the support causes deformation of the connecting arrangement so as to form a sleeve around the object. The sleeve preferably has at least one portion forming a surface in which extends at least one radial component relative to an axis X perpendicular to the plate.

Advantageously, in accordance with one example, the portion forming the surface is preferably delimited by two edges each extending respectively in a radial direction relative to the axis X. More preferably, the surface is flat. In addition, according to a preferred example, a first edge of this surface defines an external perimeter of the sleeve, and reciprocally a second edge in correspondence with the first edge defines an inner perimeter of the sleeve.

Preferably, the sleeve is perforated. Windows in the connecting arrangement particularly become visible when it is deformed in the form of a sleeve. Also, preferably, separation of the plate relative to the support is accomplished in at least one direction parallel to the axis X.

According to one advantageous feature of a preferred example, the connecting arrangement is a cellular matrix. The cells of such a matrix are hexagonal, for example. By way of example, the connecting arrangement can be a honeycomb type structure.

Preferably, the connecting arrangement includes a plurality of portions respectively delineated by two edges each extending in a radial direction relative to the axis X. For each portion, the two radial components can preferably be either in the same plane orthogonal to the axis X, or in separate but mutually parallel planes perpendicular to the axis X.

Advantageously, the connecting arrangement can be deformed so as to form a sleeve capable of surrounding the object over its full height relative to the support, and in particular relative to the axis X. This advantageous arrangement provides the ability to surround objects of different heights relative to the axis X. The arrangement is particularly advantageous for objects that have substantially the same cross-section relative to a plane orthogonal to the axis X and where the cross-sections are preferably substantially constant along the axis X.

In an advantageous example, the connecting arrangement is elastically deformable and has a spring effect tending to restore it to a rest position. Thus, the connecting arrangement tends to permanently urge the retaining device to assume a minimum size. Furthermore, this spring effect can have aesthetic merit deriving from the fact that insertion or withdrawal of the object from the device systematically induces this spring effect. For example, placement of such a retaining device in a transparent case can be envisaged so that the user can see the movements of the connecting arrangement.

Preferably, in the absence of constraint, the connecting arrangement is flattened between the plate and the support which respectively abut against each other. In this position, the plate and the support are not strictly in contact with each other inasmuch as they are separated by the connecting arrangement. Nevertheless, in this position the distance along the axis X, orthogonal to the plate between an outer face of the plate and an outer face of the support, is minimal. For example, the distance can be less than 3 centimeters. In this position, the surface defined by the portion(s) of the sleeve preferably extend substantially in a plane parallel to the plate and the support.

In a particular example of one embodiment, whether the device is in the rest position or in the form of a sleeve, the connecting arrangement is preferably always contained within the envelope surface defined between the plate and the support. A cross-section perpendicular to the axis X in the outer envelope surface defined by the connecting arrangement can be various shapes, for example, circular, oval, triangular, or polygonal.

Advantageously, the connecting arrangement can include several sheets each having an internal opening, with the sheets being interconnected at regular intervals by respective attachment between radial sections defined relative to an axis X. In this advantageous example, the sheets can be directly connected together by glue spots. Alternatively, they can be welded together or connected by other suitable expedients. Two radial sections of two separate sheets are thus glued or otherwise connected to each other.

Preferably, the sheets are flat and parallel to each other when not under strain, while they present an undulating configuration when the connecting arrangement is deformed. The sheets of the connecting arrangement are, in a preferred example, all disposed substantially orthogonal to the axis X.

According to an example of one embodiment of the connecting arrangement, the projected internal cross-section of the aperture(s) in the connecting arrangement varies in relation to its position, between its position at rest and its position when deformed. In particular, when the connecting arrangement is deformed, the projected internal cross-section of the aperture(s) is smaller than the internal cross-section of the apertures in the non-deformed connecting means. The greater the deformation of the connecting arrangement, the more the projected internal cross-section of the aperture is reduced.

For example, the cross-section of the aperture is slightly larger than the largest cross-section of the object, with the cross-sections being orthogonal to an axis along which the object is inserted into the device. A minimum inside diameter of this projected internal cross-section is chosen relative to the highest object to be inserted into the corresponding retaining device. The retaining device according to the invention can thus present a self-retaining arrangement in the form of a sleeve around the object to be retained, with the inner perimeter of the various apertures of the connecting arrangement preferably thus pressing at all levels against the outline of the object, with a certain degree of deformation of the connecting arrangement.

The projected internal cross-section of the connecting arrangement can have various shapes, for example, circular, oval, triangular or polygonal.

In accordance with an alternative or optional feature, the plate can include a closure element capable of cooperating with an upper face of the plate, and particularly with an end of the object placed in the retaining device, with this end projecting beyond the level of the opening in the upper plate. Because the closure element is mounted integrally on the plate, the object can keep the connecting arrangement deformed by holding the support away from the closure element and therefore away from the plate.

Preferably, before any deformation is applied to the connecting arrangement, the apertures are of a size substantially identical to that of the aperture in the plate. For example, the cross-section of the aperture can be slightly larger than the largest cross-section of the object, the cross-sections being considered orthogonal to the axis X on which the object is inserted into the device. By way of example, the internal cross-section of the aperture can be circular for an object to be inserted which is cylindrical.

In a particular embodiment, by way of example, the support, the connecting arrangement and/or the plate are made of cardboard and/or plastic and/or paper.

In a preferred embodiment of the retaining device, the object is inserted into the device along the axis X.

Preferably, the object comes into contact with a bottom of the support when it is placed inside the sleeve via the aperture in the plate, with this bottom of the support being opposite the aperture. When a pulling force is exerted on the plate, the object bears against the support while the pulling force produces a deformation of the connecting arrangement.

Alternatively, the pulling force exerted on the connecting arrangement can also be obtained by keeping the plate fixed relative to a case, for example, so that the weight of the object causes deformation of the connecting arrangement, and consequently separation of the support from the plate as the object comes into bearing contact on the support.

In another alternative, the plate is also kept fixed relative to the case, but in this case the deformation of the connecting arrangement is obtained by pressure exerted against the support by the object as it is being inserted. The object can be, for example, placed in a holder intended to be mounted at the bottom of the case, deformation of the connecting arrangement then takes place in an ascending movement from the bottom of the product inside the case.

By way of example, the object can be a packaging and/or dispensing device for a cosmetic product, such as a bottle of perfume or a pot of cream.

In a preferred embodiment, the object of the invention is an assembly including a case and a retaining device such as described previously, in which the plate incorporates a collar in bearing contact with a projection on the case, so that the connecting arrangement can deform inside the case. The arrangement can facilitate insertion of the device and an object into the device, with the object being then securely held by the retaining device inside the case.

In a variant, the case includes at least two openings or ledge projections designed to cooperate respectively with two retaining devices, with each of the devices being adapted to accommodate a product.

Preferably, the retaining device is itself retained, at least laterally relative to the axis X, within the internal volume of the case.

According to another object of the invention, a process is provided for setting an object in a case by a retaining device. In accordance with a preferred example, a plate of the device is positioned in bearing contact against a projection on the case, with the retaining device being oriented inside the case. The objects are inserted into the device via an aperture in the plate so as to deform a connecting arrangement connecting the plate to a support, and move the support away from this plate. The device then forms a sleeve around the object.

### BRIEF DESCRIPTION OF THE DRAWINGS

The invention will become further apparent from the following detailed description, particularly when considered in conjunction with the drawings in which:

FIG. 1 is a profile view of an example of a retaining device according to the invention in the at-rest position;

FIG. 2 is a profile view of a retaining device in a position where a connecting arrangement of the device is deformed according to the invention, inside a case viewed in lengthwise cross-section;

FIG. 3 is an exploded diagrammatic view of a connecting arrangement according to an example of the invention;

FIG. 4 is a truncated partial perspective view of a connecting arrangement according to an example of the invention;

FIG. 5 is a perspective view of an alternative embodiment of a device according to the invention;

FIG. 6 is a profile view of the device according to FIG. 5.

FIG. 7 is a perspective view of an alternative embodiment of a case including two devices according to the invention;

FIG. 8 is a side view in partial cross-section of an alternative embodiment of a device according to the invention;

FIG. 9 is a perspective view of a second alternative embodiment of a device according to the invention.

### DETAILED DESCRIPTION OF THE PREFERRED EMBODIMENTS

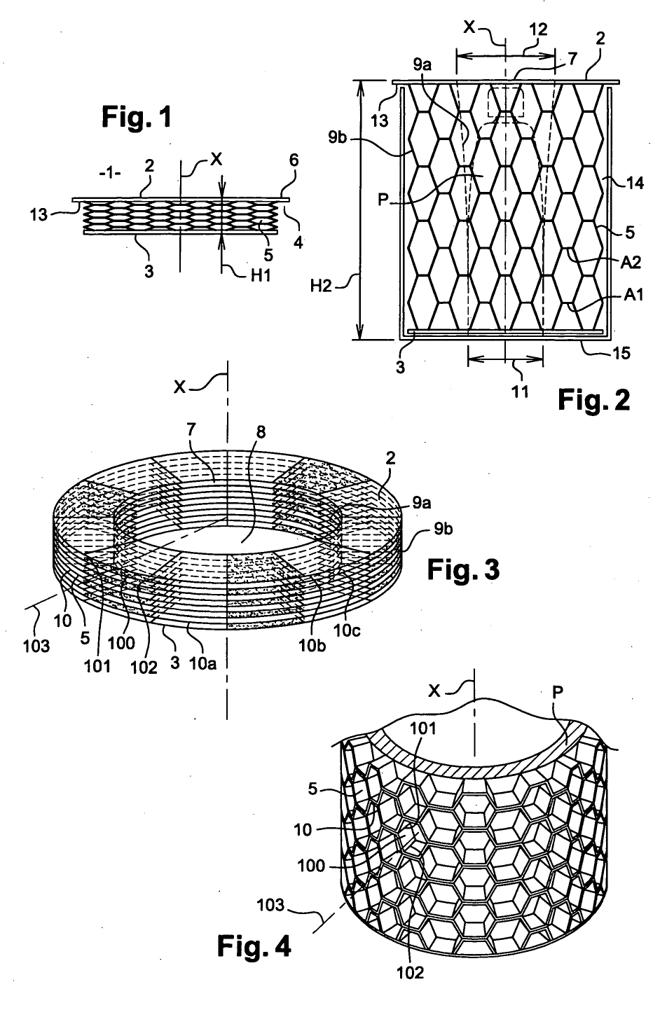

FIG. 1 illustrates a retaining device 1 according to the invention. The device 1 includes a plate 2 and a support 3. The support 3 is attached to a lower face 4 of the plate 2 by a connecting arrangement 5. The connecting arrangement 5 can be deformed so that the plate 2 moves away from the support 3 in a movement parallel to an axis X.

According to the example of this embodiment, the plate 2 is defined in a plane such that the lower face 4 and the upper face 6 of this plate 2 are parallel to this plane. Preferably, the plane of the plate 2 is defined orthogonally to the axis X.

By way of example, the plate 2 can be obtained by cutting from cardboard having a thickness, for example, on the order of 1 to several millimeters. The outline imparted to this plate 2 can be square, rectangular, circular, ovoid, or any other geometrical shape. Generally, the shape imparted to this outline is dependent on the end use of the retaining device. In effect, the plate 2 is generally cut to the measurements of a case in which the device 1 can then be placed.

The connecting arrangement 5 is preferably deformable and has shape-memory properties. It tends to revert to a rest position, for example corresponding to a position in which it forms a sleeve of small or limited height relative to the axis X. Axis X corresponds to a preferred elongating axis of the connecting arrangement 5 and of an inner space delineated by the connecting arrangement 5. Axis X also corresponds to a preferred insertion axis of an object into the inner space.

The connecting arrangement 5 in this example includes at least one portion 100 forming a surface in which at least one radial component 103 extends relative to the axis X. The radial component 103 is orthogonal to the axis X, and parallel to the plate 2. Preferably, this portion 100 presents a surface delimited by at least two edges 101 and 102 (see, e.g., FIG. 4) extending in separate radial components relative to the axis X. As the connecting arrangement 5 is deformed, this portion 100 moves relative to the axis X.

By way of example, in the case where the radial components such as 101 and 102 are defined in the same plane perpendicular to the axis X, the portion 100 can extend substantially in this plane perpendicular to axis X and is displaced linearly relative to this axis X when the connecting arrangement 5 is deformed.

As a variant, in the case where the radial components such as 101 and 102 are defined in two separate mutually parallel planes perpendicular to the axis X, the progressive deformation of the connecting arrangement 5 progressively modifies the angular position of the portion 100 relative to the axis X. By way of example, as the deformation proceeds, the portion 100 can pass from an oblique position to a position in which the portion is substantially parallel to the axis X. Before deformation of the connecting arrangement 5, this portion 100 is substantially perpendicular to the axis X, with the sleeve being then gathered into itself.

In particular, with this example, the connecting arrangement 5 includes several portions such as 100 each delineated respectively by at least two edges extending respectively on radial components relative to the axis X. For example, these portions are arranged such that they form radial apertures in the connecting arrangement 5.

More particularly, the connecting arrangement 5 is a cellular matrix, such that at least one of the cells is delineated by portions such as 100, with the portions each being respectively delineated by edges extending substantially on at least two radial components. The portions preferably extend respectively in planes containing the radial edges.

In the example illustrated in FIG. 1, the connecting arrangement 5 is of the honeycomb type. The example illustrated includes a continuous array of hexagonal cells each having at least one segment in contact with an adjacent cell. In the case where the cells are hexagonal, each cell is delineated by six separate portions such as 100, each portion being adjacent to another cell. The cells are defined such that they each have a base A1 and an apex A2 respectively forming portions such as 100 orthogonal to the axis X, the apex of a cell generally corresponding to the base of the cell above it. A base such as A1 and an apex such as A2 form examples of portions delineated by edges extending on radial components extending in the same plane perpendicular to the axis X.

The other portions delineating these cells preferably extend obliquely relative to the axis X. These other portions form examples of portions delineated by edges with each extending on radial components relative to the axis X, and with these components extending respectively in separate planes.

A portion such as 100 respectively extends along at least one of its radial components to a distance greater than I mm, and preferably to a distance greater than 3 mm.

By way of example, as can particularly be seen in FIG. 2, the connecting arrangement 5 includes eight levels of cells, with the cells on a first level being staggered relative to the cells on an adjacent level, relative to the axis X.

In FIG. 2, the connecting arrangement 5 is deformed, such that the device 1 presents a height H2 relative to the axis X substantially greater than a height H1 of this same device when it is compacted on itself as is the case in FIG. 1. In effect, in FIG. 1, the cells are almost completely flattened on themselves, and the hexagons thus formed preferentially extend on an axis orthogonal to the axis X. However, as can be seen in FIG. 2, deformation of the connecting arrangement 5 causes the cells to open out along the axis X, and each cell then defines at least one aperture extending preferentially along or in the direction to this axis X.

As can particularly be seen in FIG. 3, the plate 2 incorporates an aperture 7, and the connecting arrangement 5 has a central opening 8 extending into the aperture 7. On the other hand, the support 3 preferably does not incorporate any opening, or at least no opening of the same size as the aperture 7 and which extends into this aperture 7 and therefore the central opening 8 (in other words, if an opening is provided on the support 3, it is smaller, preferably substantially smaller than the aperture 7).

In effect, the device 1 is designed to receive an object P, which in particular can be inserted via the aperture 7 into the device 1 so that deformation of the connecting arrangement 5 causes a sleeve to be formed around the object P. Such a sleeve is preferably an open-work structure in the sense that the cells of the connecting arrangement 5 communicate between an inner perimeter 9a of the central opening 8 and an outer perimeter 9b of the connecting arrangement 5. The cells effectively form windows facilitating the deformability of the connecting arrangement 5 along the axis X.

At the outer perimeter 9b, preferably only the edges of the portions such as 100 forming the connecting arrangement 5 are visible or externally exposed. Thus, pressure exerted radially on this outer perimeter 9b bears on these edges, and the deformability of the sleeve under the effect of these radial forces is preferably practically zero as they are exerted on the edge of these portions. As the thickness of these portions is considerably less than their other particularly radial dimensions, their deformability under radial pressure is small, preferably virtually zero. Thus, the sleeve performs its function as a protective sleeve vis-á-vis external impacts having a radial component. Such a sleeve has a resistance to radial impacts substantially greater than known sleeves in the form of bellows.

The inner perimeter delineated partly by the aperture 7 and the inner perimeter 9a of the connecting arrangement 5 are preferably adapted to the outer perimeter of the object P to be inserted into the device 1. The device 1 is thus able to protect substantially the entire outer perimeter of the object while avoiding radial play of the object in the internal space delineated by the sleeve.

In the example illustrated in FIG. 3, the plate 2, the connecting arrangement 5 and the support 3 are cut so as to form a sleeve having a cylindrical outer envelope surface. Also in this example, the object P to be accommodated is preferably cylindrical, therefore the inner perimeter of the aperture 7 and the opening 8 is circular. The plate 2 is annular. The support 3 does not have an opening, and in this example corresponds to a disc. The connecting arrangement 5 is formed by connections between several sheets 10 of annular shape, by way of example. Viewing the device 1 from above, the support 3 is visible from the aperture 7. It then forms the bottom of the device 1.

In this example, the plate 2 and each sheet 10 of the connecting arrangement 5 is virtually subdivided into twelve equal and evenly-distributed sections. A cross-section of a sheet such as 10 is in this case substantially trapezoidal in shape such that the base and apex are respectively rounded and have concentric radii of curvature. These trapezoids are respectively delineated by radial components relative to the axis X. These trapezoids correspond to portions such as 100.

The first level of cells formed between the support 3 and the first sheet 10a of the connecting arrangement 5 is intended to form trapezoidal cells insofar as the support 3 is preferably not deformed by the separating movement of the plate 2.

Similarly, the lower face 4 of the plate 2 is preferably also not deformed by the separating movement of the support 3. By way of example, one section in four of this lower face is bonded to a corresponding section on an upper face of the top sheet 10b of the connecting arrangement 5, with a final level of cells formed between the plate 2 and the top sheet 10b of the connecting arrangement 5 in the form of trapezoidal cells.

The top sheet 10b of the connecting arrangement 5 in the illustrated example, includes three free sections, i.e. not connected to the plate 2. Thus, to be attached to the support 3, each central section of the group of three free sections is bonded by its lower face to a corresponding section of an adjacent sheet 10c of the connecting means, until it is finally attached to the support 3. From one sheet 10 to another, the sections that are connected are offset by 2 sections.

Clearly the invention is not limited to this embodiment and, as a variant, the inner perimeter of the aperture 7 and the opening 8 can be other than circular. Similarly, the outer perimeter of the device 1 can form an envelope surface other than cylindrical. Furthermore, the connecting arrangement 5 can include one sheet 10 connected in a regular manner to the support 3 and to the lower face 4 respectively. As a further variant, the manner in which these sheets are virtually subdivided to determine the bonding zones can also be modified. Alternatively, the sheets are welded together, and/or welded to the plate 2, and/ or welded to the support 3, or other connecting expedients could be used.

In the example illustrated in FIG. 4, an enlargement of an embodiment of the connecting arrangement 5 is shown. According to FIG. 4, the cells are superimposed in a staggered fashion with respect to each other. Each level includes more than ten cells in the illustrated example. In this example, the portions of the sheet 10 defining the perimeter of each cell respectively extend on radial components relative to the cylindrical outline of the object P. In effect, the axis of the cylinder formed by the object is an axis perpendicular to the plate 2, and can therefore be superimposed on the axis X. The inner perimeter 9a comes directly into contact with the object P.

The preferred use of the device 1 is to be deployed around the object P. The higher the object P relative to the axis X, the more it will be necessary to deform the connecting arrangement 5, drawing it out so that it forms a sleeve such that the height H2 of this sleeve is substantially the same as that of the object P. The internal cross-section of the connecting arrangement 5 can diminish slightly as it is deformed, and therefore in order to determine the dimensions of the aperture 7 and the central opening 8 to be made at the level of each of the sheets such as 10, it is preferably to consider both the cross-section and also the height on the axis X of the object P to be inserted into the device 1.

Furthermore, the connecting arrangement 5 has maximum deformability along the axis X whereby the portions respectively connecting the base to the apex for each cell are tensioned to the point of being elongated parallel to this axis X. It is therefore necessary to provide a sufficient number of levels of cells, and also to allow for the effect of reduction of the internal space delineated by the sleeve when the latter extends along the axis X.

Thus, the number of sheets such as 10 to be provided will be determined in relation to the dimensions of the cross-section and height of the object P to be inserted into the device 1, as will the bonding intervals between the sheets, as this parameter influences the maximum height that can be presented by a cell on the axis X, and therefore the maximum height that can be attained by the deformed connecting arrangement 5.

With the above arrangement, the internal space is reduced when a sheet 10 is deformed, and by virtue of the shape of this inner cross-section, deformation of the sheet 10 leads to the presentation of part of the free cross-section, connecting two bonded sections of the sheet 10 inside the initial inscribed circle, which preferably corresponds substantially to the diameter 12 of the aperture 7. Considering the internal cross-sections of each sheet such as 10, there is a reduction in the projected internal cross-section 11. The more the sheets are deformed along the axis X, the greater this reduction. When the sheets 10 are deformed, they also present an undulating configuration.

In the case where it is wished to protect a cylindrical object P in a device such as 1, if there are different models of this object P presenting different heights, the device 1 can be made so that the tallest object P can be inserted into the device 1 and be completely enveloped over its full height. The taller object P will be set inside the device 1. The walls of the cells then come into contact radially against the outer perimeter of this object. Preferably, the device is disposed in a case having sufficient depth to accommodate this taller object.

If however a second object of lesser height is inserted into the device 1 instead of the taller object, this second object will also be surrounded by the device 1. But in this case, the walls of the cells might not come into contact with this second object over its entire periphery. Some radial play will remain, unless the weight of the object is such that it causes a deformation of the connecting arrangement identical to that induced by the taller object, and that furthermore it is disposed in a case as deep as that accommodating the taller object.

To maintain the device 1 in a shape forming a sleeve around the object P to be protected, the plate 2 preferably has an outer perimeter projecting beyond the outer perimeter of the connecting arrangement 5 such that it presents a collar 13 that can particularly be seen in FIGS. 1 and 2. The collar 13 can for example be placed in a manner such that it bears on a counterpart projection or ledge on the case.

By way of example, the collar 13 can present a rectangular cross-section such that it is able for example to bear on an edge of a case 14 capable of accommodating the device 1 and the object P to be protected. In this case, the case 14 is preferably parallelepipedic in shape and incorporates a square or rectangular opening on the edges of which the collar 13 of the plate 2 can be supported.

When the collar 13 bears on a counterpart projection on a case 14, the connecting arrangement 5 and the support 3 are preferably disposed inside this case 14. The connecting arrangement 5 is folded back on itself. The insertion of an object P into the aperture 7 is such that this object comes into bearing contact with a part of support 3 opposite the aperture 7. Under the effect of the weight of the object, the connecting arrangement 5 is deformed and the support 3 is moved away from the plate 2. The sleeve is then formed.

In a first example, the deformation of the connecting arrangement 5 is limited by the depth of the case, when the object P has brought the support 3 into contact with the bottom 15 of the case 14, as is the case in FIG. 2. In a second example, the deformation of the connecting arrangement 5 is limited by the radial contact between the inner perimeter 9a of walls of the different portions of the connecting arrangement and the outer perimeter of the object P. As a variant, the deformation of the connecting arrangement 5 is simply limited by its inherent deformation limit.

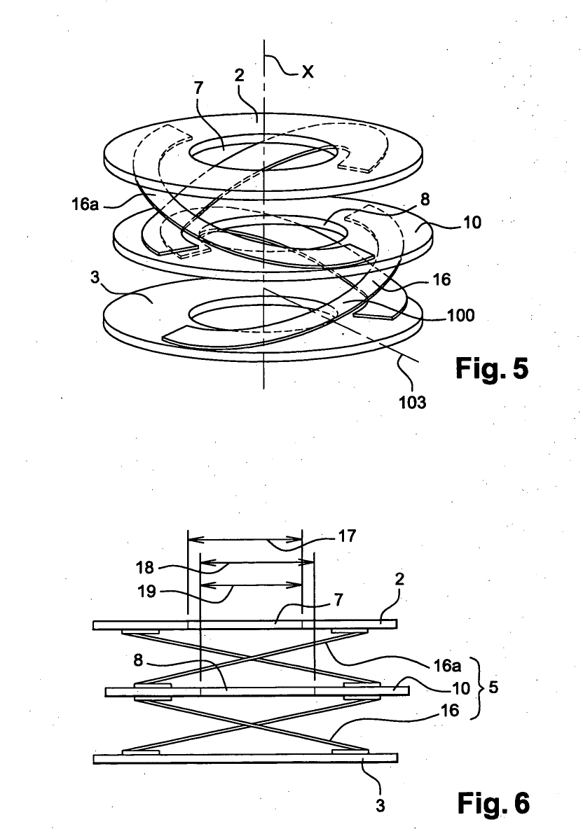

As a variant, as shown in FIG. 5, the deformable connecting arrangement 5 is formed by a sheet such as 10. However, the attachment of this sheet 10 to the plate 2 and/or the support 3 is provided by straps or segments 16 designed to make the attachments. For example, these straps or portions 16 can be cut in a manner such that each has a shape similar to a section of the sheet 10. For example, a strap 16a can be trapezoidal in shape with a rounded base and apex having identical radii of curvature, however other shapes could be used.

In this variant, when the plate 2 is moved away from the support 3, the straps 16 stand up and bend particularly the junction point respectively with the sheet 10 and the plate 2 or the support 3. During this movement, the opening 8 in the sheet 10 can be offset relative to the aperture 7. As illustrated in FIG. 6, with this example, the projected inside diameter 17 of the aperture 7 is offset relative to the projected inside diameter 18 of the opening 8. By virtue of this, the inside diameter 19 circumscribed by these two projected inside diameters 17 and 18 combined is smaller than that of the aperture 7 initially provided. This circumscribed inside diameter 19 is preferably slightly larger than the outside diameter of an object P of height H2 corresponding to this level of deformation of the connecting arrangement 5.

The invention is not limited to the embodiment as described in this variant, and the inner perimeter of the aperture 7 and the opening 8 can be other than circular. Similarly, the outer perimeter of the device 1 can form an envelope surface other than cylindrical. In addition, the connecting arrangement 5 can include several sheets such as 10 and as many straps such as 16 as necessary.

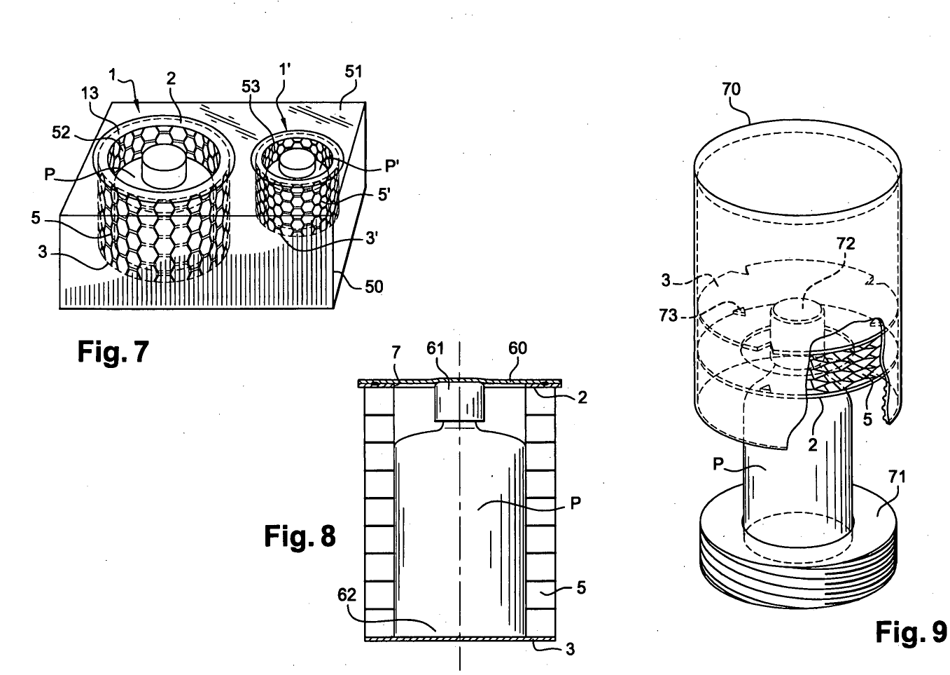

FIG. 7 shows a variant wherein a case or support 50 of parallelepipedic shape is provided such that a face 51 incorporates two openings 52 and 53 respectively designed to accommodate two retaining devices according to the invention 1 and 1′. For example, the collar 13 of the first device 1 bears against a rim defined around the first opening 52. Alternatively, this collar 13 can be fixed to a lower surface of this face 51. Insertion of the object P into the aperture 7 causes the sleeve to form and the first object P to be retained in the case 50. The second device 1′ has different dimensions for example to accommodate a different object P′. However, as a variant, the object P′ and the second device 1′ can be identical to the object P and the device 1. Preferably, a lid or cover is placed on the case 50 so as to additionally secure the objects P and P′ in their respective sleeve.

By way of example, such a case 50 can be designed thus to present several identical bottles for a treatment to be applied in several stages over time, or to provide a package in the form of a box set containing different products, for example in the same range or of the same make.

The device 1 can also perform its protective function with respect to an object P without the need for a case or an additional box. In effect, in FIG. 8, the plate 2 in this alternative embodiment is intended to cooperate with a closure element or cover 60 after the object P is inserted into the device 1. The closure element 60 is for example folded, glued or snapped onto the plate 2. It must have sufficient strength so that an end 61 of the object P bears against it, while the opposite end 62 of the object P bears against the support 3, the connecting arrangement 5 then being maintained in extension in the form of a sleeve.

In another variant, illustrated in FIG. 9, the object P is designed to be fitted via the bottom into a case 70. For example, the object P can first be mounted in a cover 71 intended to engage with the open bottom of the case 70. In this example, the collar 13 on the plate 2 can be mounted inside the case 70, integral with a projection or ledge 73 on an inner wall, at a distance from the open bottom such that the cover 71 can also be at least partially inserted into the case 70. The cover is push fit or screwed in, for example, in the case. As the cover is offered up to the open bottom, the object P is inserted into the case and an end 72 of the object P bears against the support 3 and causes deformation of the arrangement 5 so that is assumes the shape of a sleeve.

More generally, throughout the description including the claims, expressions such as including, having, has, or comprising should be understood to be synonymous with “including at least,” unless otherwise specified. The features of the different embodiments can be variously combined to produce further variants not illustrated, and it is to be understood that in practicing the invention a given embodiment need not include each of the features of the embodiments described herein.

Obviously, numerous modifications and variations of the present invention are possible in light of the above teachings. It is therefore to be understood that, within the scope of the appended claims, the invention may be practiced otherwise than as specifically described herein.

1. A retaining device for an object including:
a plate incorporating an aperture allowing insertion and withdrawal of an object;
a support;
a deformable connecting means connecting a lower face of the plate to said support;
wherein a separating movement between said plate and said support causes deformation of the connecting means so as to form a sleeve around the object, the sleeve having at least one portion forming a surface in which extends at least one radial component relative to an axis perpendicular to the plate.

2. A device according to claim 1, wherein the portion is delineated by two edges each extending in a radial direction relative to said axis.

3. A device according to claim 2, wherein the surface formed by the portion is flat.

4. A device according to claim 3, wherein the sleeve is perforated.

5. A device according to claim 4, wherein separation of the plate relative to the support is accomplished in at least one direction parallel to said axis.

6. A device according to claim 5, wherein the connecting means is a cellular matrix.

7. A device according to claim 6, wherein the cellular matrix includes cells that are hexagonal.

8. A device according to claim 5, wherein the connecting means includes a honeycomb structure.

9. A device according to claim 5, wherein the connecting means includes a plurality of portions respectively delineated by two edges each extending in a radial direction relative to said axis.

10. A device according to claim 1, wherein the connecting means can be deformed so as to form a sleeve capable of surrounding the object over its full height relative to the support.

11. A device according to claim 10, wherein the connecting means is elastically deformable and has a spring effect tending to restore it to a rest position.

12. A device according to claim 11, wherein in the absence of constraint, the connecting means is flattened between the plate and the support.

13. A device according to claim 12, wherein the connecting means includes a plurality of sheets each having an internal opening, and wherein the sheets are interconnected at regular intervals by respective attachment between radially extending sections of the sheets.

14. A device according to claim 13, wherein the sheets are directly connected together by means of glue spots.

15. A device according to claim 13, wherein the sheets are substantially flat and parallel to each other when not under strain, and wherein the sheets present an undulating configuration when the connecting means is deformed.

16. A device according to claim 15, wherein when the connecting means is deformed, a projected internal cross-section of an aperture of the connecting means is smaller than an internal cross-section of the aperture when the connecting means is not deformed.

17. A device according to claim 16, wherein the aperture of the connecting means has a size substantially identical to that of the aperture in the plate.

18. A device according to claim 17, further including an object disposed in said device, wherein the cross-section of the aperture of the connecting means is slightly larger than the largest cross-section of the object, wherein the cross-sections extend orthogonal to an axis in which the object is inserted into the device.

19. A device according to claim 18, further including a closure element capable of cooperating with said plate to keep the connecting means deformed when the object is between the support and the closure element.

20. A device according to claim 19, wherein the internal cross-section of the aperture of the connecting means is circular and wherein the object includes a cylindrical portion.

21. A device according to claim 20, wherein at least one of the support, the connecting means and the plate are made of at least one of cardboard, plastic and paper.

22. A device according to claim 1, wherein the object is inserted into the device along the axis perpendicular to the plate.

23. A device according to claim 22, wherein the object comes into bearing contact with the support.

24. A device according to claim 23, wherein the weight of the object causes deformation of the connecting means.

25. A device according to claim 24, wherein the object contains a cosmetic product.

26. A device according to claim 25, in combination with a case into which the device is inserted to form an assembly, the plate incorporating a collar in bearing contact with a portion associated with the case so that the connecting means can deform inside the case.

27. An assembly according to claim 26, wherein the device is held within an internal volume of the case.

28. A device according to claim 1, wherein separation of the plate relative to the support is accomplished in at least one direction parallel to said axis.

29. A device according to claim 1, wherein the connecting means is a cellular matrix.

30. A device according to claim 1, wherein the connecting means includes a honeycomb structure.

31. A device according to claim 1, wherein the connecting means includes a plurality of portions respectively delineated by two edges each extending in a radial direction relative to said axis.

32. A device according to claim 1, wherein the connecting means is elastically deformable and has a spring effect tending to restore it to a rest position.

33. A device according to claim 1, wherein in the absence of constraint, the connecting means is flattened between the plate and the support.

34. A device according to claim 1, wherein the connecting means includes a plurality of sheets each having an internal opening, and wherein the sheets are interconnected at regular intervals by respective attachment between radially extending sections of the sheets.

35. A device according to claim 34, wherein the sheets are directly connected together by means of glue spots.

36. A device according to claim 1, further including an object disposed inside of said device.

37. A device according to claim 36, wherein said object is a bottle of perfume.

38. A device according to claim 36, wherein said object is a pot of cream.

39. A device according to claim 36, wherein an aperture of the connecting means within which the object is disposed is slightly larger than an outer diameter of the object.

40. A device according to claim 1, in combination with a case into which the device is inserted to form an assembly, the plate incorporating a collar in bearing contact with a portion associated with the case so that the connecting means can deform inside the case.

41. An assembly according to claim 40, wherein said case includes at least two openings, and wherein a retaining device is associated with each of the at least two openings.

42. A device according to claim 1, wherein the connecting means includes a plurality of portions extending substantially perpendicular to said axis.

43. A device according to claim 42, wherein said plurality of portions define a plurality of apertures extending perpendicular to said axis when said plate is separated from said support.

44. A device according to claim 43, further including a case having at least one opening extending into an interior of the case, and wherein said plate is maintained adjacent to a mouth of the opening, and further wherein said support and said connecting means extend into the interior of the case when the device is in an extended condition.

45. A device according to claim 1, further including a case having at least one opening extending into an interior of the case, and wherein said plate is maintained adjacent to a mouth of the opening, and further wherein said support and said connecting means extend into the interior of the case when the device is in an extended condition.

46. A device according to claim 44, further including a cover which extends over said plate.

47. A device according to claim 1, further including a cover which extends over said plate.

48. A device according to claim 1, further including:
a case within which at least a portion of said device extends when said device is in an extended position;
said case including an opening into which said device extends; and
a cover which covers the opening of said case.

49. An assembly according to claim 48, wherein the cover at least partially extends into said opening of said case.

50. A process for setting an object in a case with a retaining device, including:
positioning a plate of the device in bearing contact against a portion of the case, with the retaining device being oriented to at least partially extend inside the case,
inserting an object into the device via an aperture in the plate so as to deform a connecting means connecting the plate to a support; and
moving the support away from the plate, such that the device forms a sleeve around the object.

51. A retaining device for a object including:
a plate having an aperture allowing insertion and withdrawal of an object;
a support;
a connecting arrangement extending between said plate and said support, wherein said connecting arrangement is extensible such that said device can be moved from a collapsed position in which said plate is proximate to said support to an extended position in which said plate is spaced from said support, and wherein said connecting arrangement forms a sleeve around the object inserted into said aperture with the device in the extended position.

52. A device according to claim 51, wherein the support and plate are relatively moved along a first direction as the device is moved from the collapsed position to the extended position, and wherein the connecting arrangement includes a plurality of apertures extending substantially perpendicular to said first direction.

53. A device according to claim 51, in combination with a case having an opening, and wherein said device is mounted to said case such that said device at least partially extends into said opening.

54. The device and case according to claim 53, wherein a direction in which said device is inserted into said opening is substantially parallel to a direction of relative movement between said support and said plate as said device is moved from said collapsed position to said extended position.

55. A device and case according to claim 53, further including a cover extending over the opening of the case.

56. A device according to claim 51, further including a cover extending over the aperture of said plate.

57. A device according to claim 51, wherein the support and plate are relatively moved along a first direction as the device is moved from the collapsed position to the extended position, and wherein the connecting arrangement includes a plurality of portions extending substantially perpendicular to said first direction.
